(19) United States
(12) Patent Application Publication
(10) Pub. No.: US 2026/0249868 A1
(43) Pub. Date: Aug. 27, 2026

(54) ALERT SYSTEM FOR GOLF COURSE

(71) Applicant: Textron Inc., Providence, RI (US)

(72) Inventors: Preston Sering Easley, Martinez, GA (US); Cole Elliott O'Brien, North Augusta, SC (US); Payton Michael Loppnow, Augusta, GA (US)

(73) Assignee: Textron Inc., Providence, RI (US)

(21) Appl. No.: 19/062,953

(22) Filed: Feb. 25, 2025

(51) Int. Cl. B60W 50/14; B60W 40/08; H04W 4/02; H04W 4/021

(52) U.S. Cl. CPC B60W 50/14; B60W 40/08; H04W 4/021; H04W 4/025; B60W 2040/0809; B60W 2040/0881; B60W 2050/143; B60W 2050/146; B60W 2300/405; B60W 2540/043; B60W 2554/80; B60W 2555/20; B60W 2556/50

(57) ABSTRACT

A golf system includes one or more processing circuits configured to generate an alert for an occupant of a golf vehicle, the alert including at least one of (i) an alert time or (ii) an alert condition, determine that the golf vehicle is active, and provide the alert to the occupant of the golf vehicle using at least one of a display device or a speaker of the golf vehicle. The alert is provided at least one of (i) at or after the alert time or (ii) in response to the alert condition being satisfied.

### BACKGROUND

Golf carts are commonly used by golfers while playing a round of golf to drive between holes, to their ball, and to carry their bags. Other vehicles, such as drink carts, ground maintenance vehicles, recreational vehicles, utility vehicles, etc. are also commonly found at a golf course. Messages may be provided to the golf cart or the other vehicles for various reasons such as providing weather conditions, course status, advertisements, etc.

### SUMMARY

One embodiment relates to a golf system. The golf system includes one or more processing circuits configured to generate an alert for an occupant of a golf vehicle, the alert including at least one of (i) an alert time or (ii) an alert condition, determine that the golf vehicle is active, and provide the alert to the occupant of the golf vehicle using at least one of a display device or a speaker of the golf vehicle. The alert is provided at least one of (i) at or after the alert time or (ii) in response to the alert condition being satisfied.

Another embodiment relates to a golf system. The golf system includes a golf vehicle including an operator interface and a first processing circuit, and a computing system remote from the golf vehicle, the computing system including a second processing circuit. The second processing circuit is configured to generate an alert for an occupant of the golf vehicle, the alert including at least one of (i) an alert time or (ii) an alert condition. The second processing circuit is configured to determine that the golf vehicle is active. The first processing circuit is configured to control the operator interface to provide the alert to the occupant of the golf vehicle. The alert is provided at least one of (i) at or after the alert time or (ii) in response to the alert condition being satisfied.

Still another embodiment relates to a golf system. The golf system includes one or more processing circuits configured to generate, remote from a golf vehicle, an alert for an occupant of the golf vehicle, the alert including at least one of (i) an alert time or (ii) an alert condition, determine that the golf vehicle is active based on (i) a presence of the occupant in the golf vehicle or (ii) a location of the golf vehicle indicating that the golf vehicle is moving, and provide the alert to the occupant of the golf vehicle using at least one of a display device or a speaker of the golf vehicle. The alert is provided at least one of (i) at or after the alert time or (ii) in response to the alert condition being satisfied. The alert is provided based on a type of the golf vehicle such that the alert is provided to a first respective golf vehicle of a first type and not provided to a second respective golf vehicle of a second type different than the first type at least one of (i) at or after the alert time or (ii) in response to the alert condition being satisfied.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is another schematic block diagram of the vehicle of FIG. 1, according to an exemplary embodiment.

FIG. 4 is a schematic block diagram of a fleet monitoring and control system including a plurality of the vehicles of FIG. 1, according to an exemplary embodiment.

FIG. 5 is a top view of a golf course including the vehicle of FIG. 1, according to an exemplary embodiment.

FIG. 6 is a top view of a golf course including the vehicle of FIG. 1, according to an exemplary embodiment.

FIG. 7 is a graphical user interface including a message alert, according to an exemplary embodiment.

FIG. 8 is the graphical user interface of FIG. 7 including an audio alert, according to an exemplary embodiment.

FIG. 9 is the graphical user interface of FIG. 7 including a video alert, according to an exemplary embodiment.

FIG. 10 is a graphical user interface including an alert dashboard, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

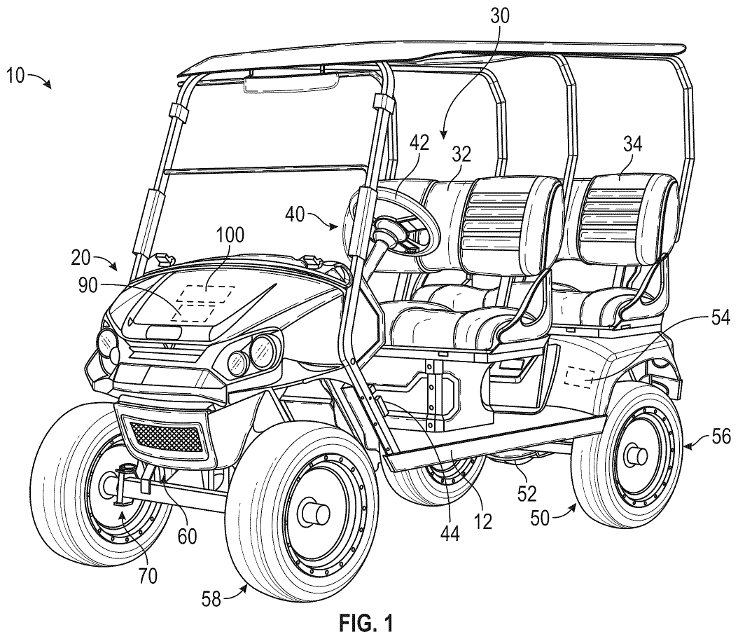

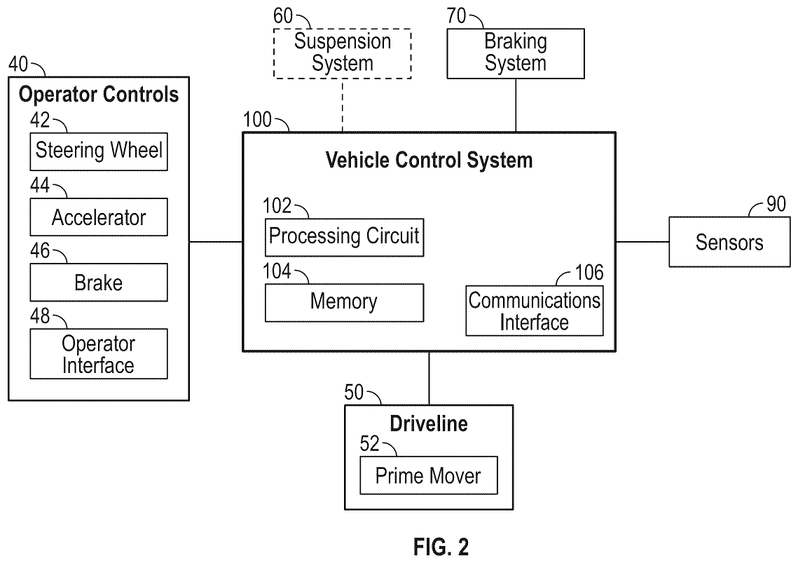

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart or vehicle, an all-terrain vehicle (“ATV”), a utility task vehicle (“UTV”), a low speed vehicle (“LSV”), a personal transport vehicle (“PTV”), a hauler, and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, another type of chore product that may be used on a golf course, a ground support equipment (“GSE”) that may be used at an airport, and/or still other off-road machines or vehicles.

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input devices may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., the motor 53) and the energy storage 54 is a battery system (e.g., the battery module 57, the add-on battery module(s) 59, etc.). In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Electrified Driveline

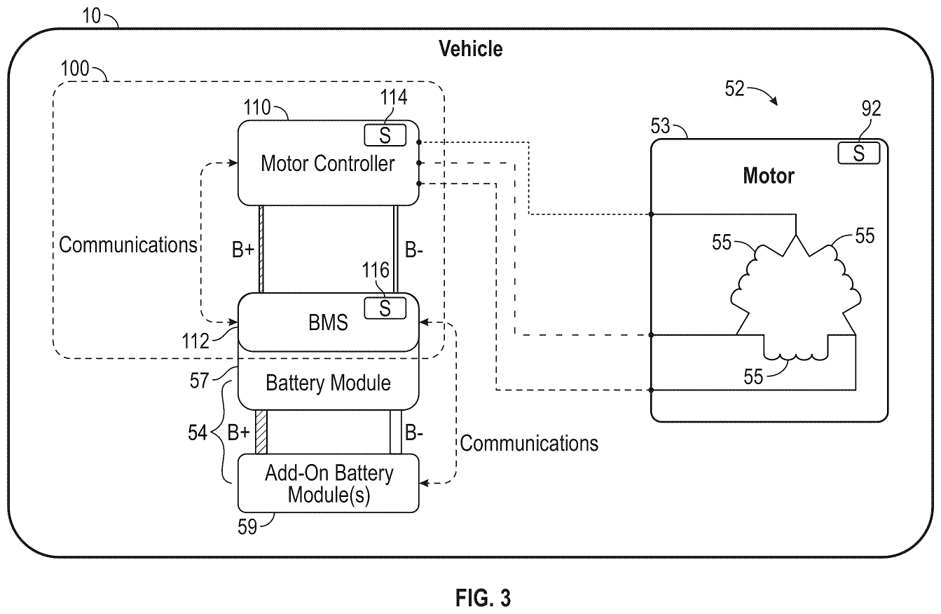

According to the exemplary embodiments shown in FIG. 3, the driveline 50 of the vehicle 10 is configured as an electrified driveline where (a) the prime mover 52 is configured as a three-phase, alternating current (“AC”) electric motor, shown as motor 53, including three sets of windings, shown as motor windings 55, and a first sensor, shown as motor sensor 92; (b) the energy storage 54 is configured as a battery system including a first battery pack or module, shown as battery module 57, and one or more second battery packs or modules, shown as add-on battery module(s) 59, electrically coupled to the battery module 57 in parallel; and (c) the vehicle control system 100 includes (i) a first controller, shown as motor controller 110, coupled to the motor 53 and including a second sensor, shown as motor controller sensor 114, and (ii) a second controller, shown as battery management system (“BMS”) 112, coupled to the motor controller 110 and the energy storage 54 (e.g., the battery system, the battery module 57, the add-on battery module(s) 59, etc.) and including a third sensor, shown as BMS sensor 116. In some embodiments, the motor 53 is configured as a separately excited DC motor. The motor sensor 92, the motor controller sensor 114, and/or the BMS sensor 116 may include a temperature sensor, a voltage sensor, a current sensor, a speed sensor, and/or another suitable sensor to facilitate monitoring at least one of the operational parameters (e.g., temperature, voltage, current, speed, SOC, rate of charge, rate of discharge, etc.) of the motor 53, the motor controller 110, the BMS 112, the battery module 57, and/or the add-on battery modules(s) 59. The motor controller 110 and the BMS 112 may each include a processing circuit 102, a memory 104, and a communications interface 106.

According to an exemplary embodiment, each of the battery module 57 and the add-on battery module(s) 59 of the battery system includes one or more rows and/or groups of battery cells. The BMS 112 may be configured to monitor characteristics of the rows and/or groups of battery cells and/or individual cells of the battery module 57 and the add-on battery module(s) 59 (e.g., using data acquired by the BMS sensor 116) including, but not limited to, voltage, temperature, current, and state of charge (“SOC”). The BMS 112 may also be configured to provide direct current (“DC”) power from the battery system to the motor controller 110 to power the motor 53 based on driving demands of the vehicle 10.

According to an exemplary embodiment, the motor controller 110 is configured to manage the power supplied to the motor 53. By way of example, the motor controller 110 may be configured to modulate the voltage, current, phase, and/or frequency of the power sent to the motor windings 55, which can influence the torque and speed output provided by the motor 53. In some embodiments, the motor controller 110 is configured to control a type of power, AC power or DC power, delivered to the motor 53. By way of example, the motor controller 110 may be configured to convert the type of power from DC power to AC power and/or regulate the AC power or DC power depending on the intended function of the motor 53. The motor controller 110 may include components to invert, convert, or otherwise modulate DC power and/or AC power.

As shown in FIG. 3, the energy storage 54 is configured to supply (e.g., via electrical wiring, electrical connections, etc.) DC power to the motor controller 110. In some embodiments, the DC power flows from the energy storage 54, through the BMS 112, and to the motor controller 110. The BMS 112 and the motor controller 110 may include communication interfaces (e.g., communications interfaces 106) that facilitate exchanging data related to operational status, command signals, and feedback therebetween. The BMS 112 and the add-on battery module 59 (e.g., a BMS thereof) may include communication interfaces that facilitate exchanging data related to operational status, command signals, and feedback therebetween. The add-on battery module(s) 59 is(are) configured to provide additional battery cells and increase the total energy storage capacity of the energy storage 54. As shown in FIG. 3, the battery module 57 and the add-on battery module(s) 59 are connected in parallel (e.g., via wires, connection busses, etc.) to provide for a pathway of electrical transfer. In other embodiments, the battery module 57 and the add-on battery module(s) 59 are connected in series.

According to an exemplary embodiment, the BMS 112 is configured to monitor (e.g., continuously, periodically, etc.) various parameters of the energy storage 54, including voltage, current, and temperature of each cell, rows/groups, and/or module within the energy storage 54. In some embodiments, the BMS 112 is configured to calculate or otherwise determine the SOC of the energy storage 54, the battery module 57, and/or the add-on battery module(s) 59. In some embodiments, the BMS 112 is configured to redistribute charge among the cells, rows/groups, and/or the modules to ensure an equal or substantially equal charge level throughout the energy storage 54. The BMS 112 can communicate with other systems or components or the vehicle 10 or with external devices (e.g., the remote systems 240) to report on battery status and diagnostics and/or to receive control commands.

According to an exemplary embodiment, the BMS 112 is configured to detect faults or failures in the energy storage 54 that may potentially lead to or that have caused an overcharge condition and, thereby, a thermal runaway event. By way of example, the BMS 112 may be configured to monitor the voltage of individual cells, rows/groups, or modules of the energy storage 54, and when deviations from normal voltage levels occur beyond a nominal range, the BMS 112 may determine that a fault or failure is present and that there is a potential for an overcharge condition or that there is an actual overcharge condition. In some implementations, the BMS 112 is configured to detect voltage imbalance or voltage imbalance trends. By way of another example, the BMS 112 may additionally or alternatively be configured to monitor current flows during charging and discharging of the energy storage 54 and identify unexpected fluctuations in current that may indicate that a fault or failure is present and that there is a potential for an overcharge condition or that there is an actual overcharge condition. By way of still another example, the BMS 112 may additionally or alternatively be configured to monitor the temperature of the cells, rows/groups, and/or modules of the energy storage 54 and identify anomalously high temperatures that may indicate that a fault or failure is present and that there is a potential for an overcharge condition or that there is an actual overcharge condition. It should be understood that the above example of detecting faults, failures, or overcharge conditions is provided for example purposes only and is not exhaustive. Other methods or techniques may be implemented to detect faults, failures, or overcharge conditions, which are intended to be included within the scope of the present disclosure. Additional details regarding fault detection regarding the energy storage 54 is described in greater detail herein. Further details regarding fault detection, including voltage imbalance, may be found in U.S. patent application Ser. No. 18/884,363, filed Sep. 13, 2024, which is incorporated herein by reference in its entirety.

### Fleet Monitoring and Control System

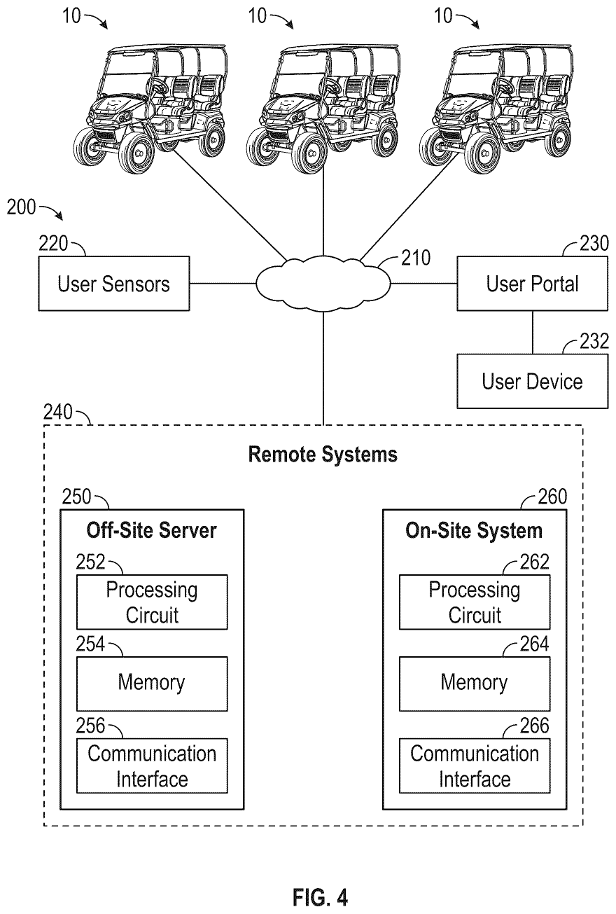

As shown in FIG. 4, a site monitoring and control system, shown as fleet monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210. In some embodiments, the fleet monitoring and control system 200 does not includes the user portal 230 and/or the user device 232.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, a heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc. ; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons breaking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 4, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 4, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 4, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Message System

According to an exemplary embodiment, the fleet monitoring and control system 200, including the vehicle control system 100, the user sensors 220, the user portal 230, and the remote systems 240, is configured to facilitate improving or enhancing location detection of the vehicles 10 and associated control thereof based on location. Further, it should be understood that any of the functions or processes described herein with respect to the fleet monitoring and control system 200 may be performed by the vehicle control system 100 and/or the remote systems 240. By way of example, data collection may be performed by the vehicle control system 100 and data analytics may be performed by the vehicle control system 100. By way of another example, data collection may be performed by the vehicle control system 100 and data analytics may be performed by the remote systems 240. By way of yet another example, data collection may be performed by the vehicle control system 100, a first portion of data analytics may be performed by the vehicle control system 100, and a second portion of data analytics may be performed by the remote systems 240. By way of still another example, a first portion of data collection may be performed by the vehicle control system 100, a second portion of data collection may be performed by the remote systems 240, and data analytics may be performed by the vehicle control system 100 and/or the remote systems 240.

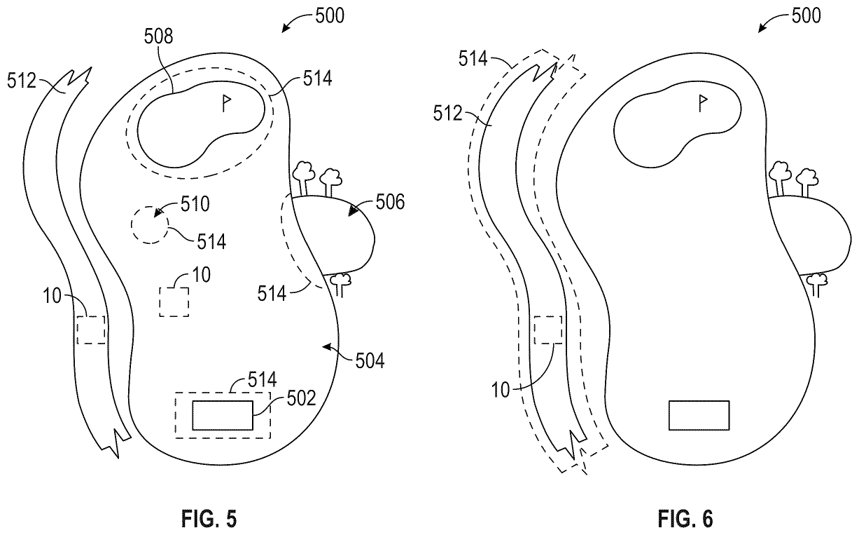

As shown in FIGS. 5 and 6, the vehicle 10 may be a golf cart driven by an operator playing golf on a golf course 500. In some embodiments, the vehicle 10 is a drink cart, a cart driven by an employee of the golf course 500 monitoring the pace of play of golfers, a cart driven by the maintenance crew working at the golf course 500, or another type of vehicle or vehicle commonly found at golf courses (e.g., a turf mower, a sprayer, an aerator, a bunker rake, etc.). A hole of the golf course 500 is shown including a tee box 502; a fairway 504; a water hazard, woods, fescue, etc., shown as out-of-bounds area 506; a putting green, shown as green 508; an area in the fairway 504 that is under repair, a non-playable area, etc., shown as hazard 510; and a path, a trail, a cart route, etc., shown as cart path 512.

The golf course 500 includes areas that should not be driven on, in, or around by the vehicle 10. By way of example, these areas may include the tee box 502, the out-of-bounds area 506, the fairway 504 during certain conditions (e.g., rain, flooding, under repair, etc.), the green 508, the hazard 510, private property along the golf course 500, a club house of the golf course 500, roped-off areas, dry/brown grass areas, areas with new sod, and/or another areas of the golf course 500. Driving on, in, or around these areas by the vehicle 10 may damage the golf course 500, be dangerous for an operator of the vehicle 10, damage the vehicle 10, be illegal (e.g., trespassing on private property), etc. Collectively, these areas are hereinafter referred to as restricted areas. Accordingly, one or more geofences (e.g., a virtual boundary, a virtual fence, etc.), shown as geofences 514, may be established around the restricted areas. The geofences 514 may be areas or boundaries defined around the restricted areas to control and manage the operation of the vehicle 10 on the golf course 500. By way of example, when the vehicle 10 is driven beyond the virtual boundary of the geofence 514 (i.e., driven into a restricted area), the operation of the prime mover 52 of the vehicle 10 may be limited (e.g., limit speeds below a speed threshold such as below 5 miles per hour, prevent forward travel of the vehicle 10, limit the vehicle 10 to backward travel only, disabled, limited or restricted operation, etc.). Areas of the golf course 500, such as the cart path 512, a parking lot of the golf course 500, the fairway 504, a cart return area, etc. that are not restricted areas defined by a geofence 514 may be drivable (e.g., navigable, permitted, unrestricted operation, etc.) by the vehicle 10, and are hereinafter referred to as the drivable areas. In some embodiments, a cart path only rule may be implemented where the vehicle 10 is supposed to drive on the cart path 512 only (e.g., after or during heavy rainfall). In such an embodiment, the geofence 514 may be established everywhere except for the cart path 512.

As shown in FIG. 6, the geofence 514 is established around the cart path 512. The geofence 514 formed around the cart path 512 may facilitate implementing the cart path only rule where the vehicle 10 is supposed to drive on the cart path 512 only (e.g., after or during heavy rainfall, to avoid ground under repair, when the cart path 512 is a bridge crossing a river/pond, etc.). As shown in FIG. 6, rather than defining geofences 514 around the restricted areas (i.e., everywhere but the cart path 512), a geofence 514 (e.g., a cart path geofence) is formed around the cart path 512. By way of example, when the vehicle 10 is driven beyond the virtual boundary of the geofence 514 (i.e., driven off of the cart path 512 and into a restricted area), the operation of the prime mover 52 of the vehicle 10 may be limited (e.g., limit speeds below a speed threshold such as below 5 miles per hour, prevent forward travel of the vehicle 10, limit the vehicle 10 to backward travel only, disabled, limited or restricted operation, etc.). In some embodiments, the geofences 514 are established around the restricted areas (as shown in FIG. 5) and around the drivable areas (e.g., around the cart path 512 as shown in FIG. 6).

The fleet monitoring and control system 200 may control an operation of the operator controls 40, the driveline 50, the suspension system 60, the braking system 70, and/or any other component of the vehicle 10 based on the true location (e.g., a corrected position, an actual location, etc.) of the vehicle 10 relative to the restricted areas and the drivable areas. By way of example, the fleet monitoring and control system 200 may determine, based on the true location, that the vehicle 10 is operating (e.g., driving forward, driving backward, idling, stopped, parked, etc.) (i) in a drivable area defined by a respective geofence 514, (ii) near a respective geofence 514 (e.g., within 5 yards of the respective geofence 514, within 10 yards of the respective geofence 514, etc.), or (iii) in a restricted area defined by a respective geofence 514.

In response to a determination that the vehicle 10 is operating in a drivable area, the fleet monitoring and control system 200 may facilitate (e.g., permit operation of the vehicle 10 in a first mode of operation) normal or unrestricted operation of the operator controls 40, the driveline 50, the suspension system 60, the braking system 70, and/or any other component of the vehicle 10. By way of example, in response to a determination that the vehicle 10 is operating in a drivable area and outside of a restricted area defined by the geofence 514, the fleet monitoring and control system 200 may permit operation of the vehicle 10 in the first mode of operation. By way of another example, in response to a determination that the vehicle 10 is operating in a drivable area defined by the geofence 514 (e.g., operating on the cart path 512 within the cart path geofence, operating on the fairway 504 within a fairway geofence, etc.) the fleet monitoring and control system 200 may permit operation of the vehicle 10 in the first mode of operation.

In response to a determination that the vehicle 10 is operating in or near a restricted area (e.g., near or in the geofence 514), the fleet monitoring and control system 200 may limit operation (e.g., limit operation of the vehicle 10 in a second mode of operation) of the operator controls 40, the driveline 50, the suspension system 60, the braking system 70, and/or any other component of the vehicle 10. By way of example, the fleet monitoring and control system 200 may limit operation of the prime mover 52 such that the vehicle 10 (i) cannot exceed a threshold speed (e.g., 5 miles per hour, 2 miles per hour, etc.), (ii) is limited to rearward travel, and/or (iii) any other control to limit operation of the vehicle 10. In such an example, to transition the vehicle 10 to the second mode of operation, the fleet monitoring and control system 200 may (i) shift the vehicle 10 into neutral (e.g., such that no power is transmitted to the prime mover 52) and/or (ii) operate the braking system 70 to slow the vehicle 10 to a stop. The vehicle 10 may be limited to the second mode of operation until the vehicle 10 navigates (e.g., is navigated by an operator) to the drivable area.

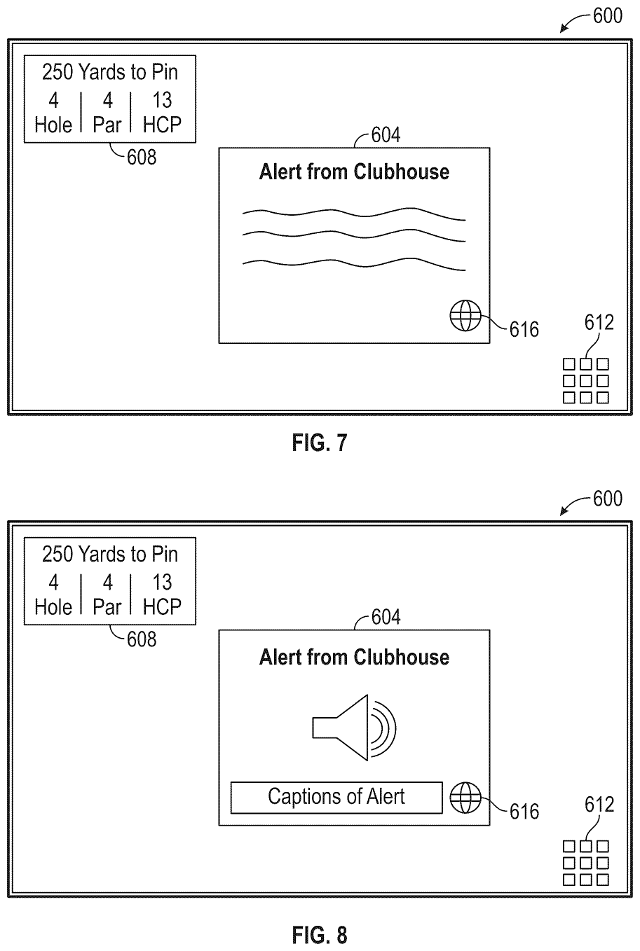

As shown in FIGS. 7-9, a first graphical user interface (“GUI”), shown as vehicle GUI 600, is configured to provide one or more views, menus, buttons, etc., to facilitate providing an alert (e.g., message alerts, audio alerts, media alerts, advertisements, etc.), shown as alert 604, at the vehicle 10. In some embodiments, as discussed in greater detail with respect to FIG. 10, the alert 604 is generated at the user device 232 (e.g., via the alert dashboard 620). The vehicle GUI 600 is configured to be provided to the operator interface 48 for display on the one or more displays thereof. The operator interface 48 is configured to receive an input from the user to provide the user with the ability to control one or more functions of and/or provide commands to the vehicle GUI 600. By way of example, the user may interact with (e.g., engage with, provide an input to, etc.) the vehicle GUI 600 via the operator interface 48 to cause the vehicle GUI 600 to display one or more additional elements, menus, panels, etc.

As shown in FIGS. 7-9, the vehicle GUI 600 includes a hole information panel, shown as hole information 608. The hole information 608 includes information regarding the hole at which the vehicle 10 is located such as yardage information (e.g., yardage from the tee to the pin, yardage from the vehicle 10 to the pin, etc.), the hole number (e.g., hole 4), par information (e.g., par 3, par 4, par 5, etc.), handicap information (e.g., 13 handicap (“HCP”), indicating a difficulty of the hole, etc.), among other information. In some embodiments, the vehicle GUI 600 includes a golf course view panel configured to display (i) the tee box 502, the fairway 504, the out-of-bounds area 506, the green 508, the hazard 510, etc. of one or more holes, (ii) the cart path 512, and (iii) any other features of the golf course 500. In such embodiments, the user may interact with the golf course view panel to zoom in to view a particular area of the golf course 500, zoom out to view a larger area of the golf course 500, pan across the map to view different areas of the golf course 500, rotate the map, and/or otherwise interact with the golf course view panel to manipulate a view of the golf course 500 displayed by the golf course view panel. In some embodiments, the user provides an input to the golf course view panel specifying a respective hole of the golf course 500, and the vehicle GUI 600 is configured to display the respective hole. In some embodiments, the golf course view panel is configured to display real-time updates regarding the locations of the vehicles 10 on the golf course 500.

As shown in FIGS. 7-9, the vehicle GUI 600 includes a first element, shown as main menu button 612, configured to provide the user with the ability to have the vehicle GUI 600 display one or more elements or views (e.g., a home view, a hole view, etc.); and a second element, shown as language button 616, configured to provide the user with the ability to identify a language. Using the language button 616, the user may identify a language that they wish the vehicle GUI 600 to be provided in (e.g., a language they wish text to be displayed in, a language they wish audio to be played in, etc.). By way of example, the alert 604 may be generated in a first language and provided in (e.g., translated to) a second language (e.g., the language identified using the language button 616). As shown in FIGS. 7-9, the hole information 608, the main menu button 612, and the language button 616 are provided on the vehicle GUI 600 regardless of the view, information, menus, etc., displayed thereon. In some embodiments, the alert 604 provided to the vehicle 10 for display on the vehicle GUI 600 obstructs at least a portion of the hole information 608, the main menu button 612, and/or the language button 616.

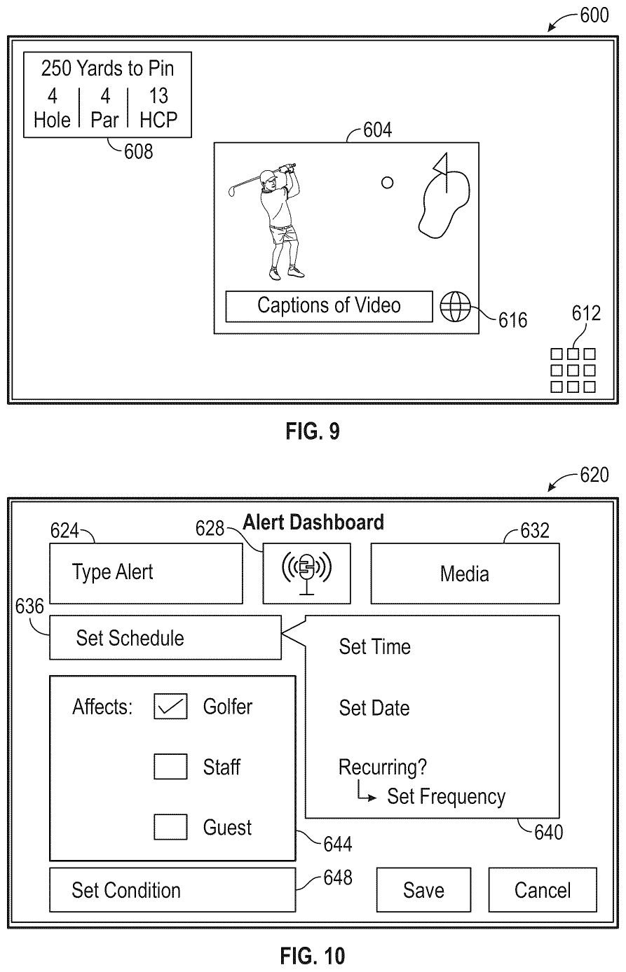

As shown in FIGS. 7-9, the vehicle GUI 600 is configured to display (or display an indication of) and/or the speaker of the operator interface 48 is configured to audibly play (i) a first alert 604 such as a text message, text alert, advertisement message, etc., (ii) a second alert 604 such as an audio recording, audible advertisement alert, etc., and/or (iii) a third alert 604 such as a video, video advertisement, etc., to provide the first alert 604, the second alert 604, and/or the third alert 604 to the operator of the vehicle 10. According to an exemplary embodiment, the vehicle GUI 600 is configured to provide the alert 604 (e.g., visually via a display of the operator interface 48, audibly via a speaker of the operator interface 48, in a tactile manner by shaking the steering wheel 42, etc.) to the operator of the vehicle 10. As shown in FIG. 7, the alert 604 includes text displayed on the vehicle GUI 600. In some embodiments, the alert 604 is generated at the user device 232 in response to the user providing a text input (e.g., a typed input) to the user device 232. As shown in FIG. 8, the vehicle GUI 600 is configured to display an indication of the audio included in the alert 604 being provided. By way of example, a speaker of the operator interface 48 may be configured to audibly play the alert 604. In some embodiments, the alert 604 is generated at the user device 232 in response to the user providing an audio input (e.g., a voice recording) to the user device 232. In other embodiments, the user provides a text input to the user device 232, and a text-to-speech module (located at the remote systems 240 and/or the vehicle 10) generates (e.g., from the text input) the alert 604. As shown in FIG. 9, the alert 604 includes one or more videos, graphic interchange format (“GIF”) files, etc. provided for display on the vehicle GUI 600. In some embodiments, the alert 604 includes an audio file associated therewith and provided to the vehicle 10 to be played by the speaker of the operator interface 48 in coordination with the video displayed on the vehicle GUI 600. In some embodiments, the alert 604 is generated at the user device 232 in response to the user providing a video input to the user device 232. In some embodiments, the vehicle GUI 600 is configured to display captions of the audio and/or video of the alert 604 being provided. By way of example, a speech-to-text module (located at the remote systems 240 and/or the vehicle 10) may generate the captions based on the alert 604 and provide the captions to the vehicle GUI 600 for display thereon. The vehicle GUI 600 is configured to provide the alert 604 in the identified language (e.g., the language identified using the language button 616). In some embodiments, as discussed in greater detail with respect to FIG. 10, the alert 604 is generated at the user device 232. In other embodiments, the alert 604 is generated at a second vehicle 10.

As shown in FIG. 10, a second GUI, shown as alert dashboard 620, is configured to provide one or more views, menus, buttons, etc., to facilitate generating the alert 604 (e.g., the text alert, the audio alert, the video alert, etc.). Generating the alert 604 as discussed herein may include creating a new alert 604, editing an existing alert 604, configuring one or more settings associated with the alert 604, among other controls relating to generating one or more alerts 604. The alert dashboard 620 is configured to be provided to the user device 232 for display on the one or more displays thereof. The user device 232 is configured to receive an input from the user to provide the user with the ability to control one or more functions of and/or provide commands to the alert dashboard 620 and the fleet monitoring and control system 200. By way of, the user may interact with (e.g., engage with, provide an input to, etc.) the alert dashboard 620 via the user device 232 to cause the alert dashboard 620 to display one or more additional elements, menus, panels, etc. In some embodiments, the alert dashboard 620 is configured to be provided to the operator interface 48 for display on the one or more displays thereof.

As shown in FIG. 10, the alert dashboard 620 includes (i) a first element, shown as type alert button 624, (ii) a second element, shown as audio button 628, and (iii) a third element, shown as media button 632, configured to facilitate generating the alert 604 at the alert dashboard 620 (e.g., at the user device 232). The type alert button 624 is configured to provide the user with the ability to provide a text input (e.g., a typed input, a typed message, etc.) to generate the alert 604. By way of example, the user may select the type alert button 624 and, in response to the selection, the alert dashboard 620 may display a keyboard configured to receive an input from the user to generate (e.g., type) the alert 604. By way of another example, the user device 232 may include an input device such as a keyboard configured to receive an input from the user to generate (e.g., type) the alert 604. As shown in FIG. 10, the audio button 628 is configured to provide the user with the ability to initiate recording an audio message (e.g., a voice recording) to generate the alert 604 (e.g., an audio alert). In some embodiments, the alert 604 is generated at the user device 232 using a microphone thereof. As shown in FIG. 10, the media button 632 is configured to provide the user with the ability to select (e.g., upload) media such as an image, a video, and/or an audio file to generate the alert 604 including the selected media. By way of example, the media may be selected from media stored by the user device 232, the memory 254 of the off-site server 250, and/or the memory 264 of the on-site system 260. In some embodiments, the alert 604 includes a message alert generated via the type alert button 624, an audio alert generated via the audio button 628, and/or a media alert generated via the media button 632. In some embodiments, the alert dashboard 620 facilitates configuring one or more settings (e.g., a schedule, a type, an alert condition, etc.) associated with an existing or previously generated alert 604.

In some embodiments, the alert 604 generated using the alert dashboard 620 includes messages from the clubhouse, course instructions and rules (e.g., 90-degree rules, cart path only rules, etc.), hole-specific information (e.g., hole number, yardage, handicap, etc.), pace of play messages (e.g., to speed up or slow down the pace of play), safety warnings (e.g., weather warnings, a real-time radar, etc.), geofence warnings (e.g., messages indicative of a location of a respective geofence 514, geofence violation warnings, instructions regarding how to exit a respective geofence 514, etc.), end of round messages, among others. In some embodiments, the alert 604 includes an advertisement (e.g., a picture, a video, an audio file, etc.). In such embodiments, the advertisement may include advertisements from businesses, course specific promotions (e.g., food and drink specials, equipment and apparel sales, etc.), course specific events (e.g., golf lessons, upcoming outings, etc.), among others.

As shown in FIG. 10, the alert dashboard 620 includes a fourth button, shown as schedule element 636, configured to provide the user with the ability to identify (e.g., set, input, define, specify, etc.) a schedule associated with (e.g., included in) the alert 604. According to an exemplary embodiment, the fleet monitoring and control system 200 is configured to provide the alert 604 (e.g., to the vehicle 10) in accordance with the schedule associated therewith. The schedule element 636 includes a menu, shown as schedule menu 640. In some embodiments, the schedule menu 640 is always displayed on the alert dashboard 620 when the schedule element 636 is displayed on the alert dashboard 620. In other embodiments, the schedule menu 640 is displayed (e.g., as a pop-up menu) in response to a selection of the schedule element 636. As shown in FIG. 10, the schedule menu 640 includes one or more features (e.g., elements, buttons, etc.) configured to provide the user with the ability to tailor the schedule, and thereby identify an alert time at or after which the alert 604 is provided. The schedule menu 640 is configured to provide the user with the ability to set a time (e.g., hour, minute, etc.) and a date (e.g., day of the month, day of the week, etc.) they wish the alert 604 to be provided.

As discussed herein, the time and date identified using the schedule menu 640 may be referred to hereinafter as the “alert time.” In other words, the alert time may include any time or date associated with the schedule at or after which the alert 604 is provided. In some embodiments, the alert time included in the alert 604 includes a time (e.g., 7:30 AM, 12:00 PM, 6:30 PM, etc.), a day of the week (e.g., Monday, Tuesday, Wednesday, Thursday, Friday, Saturday, Sunday), and/or a date (e.g., January 28^{th}, July 4^{th}, August 11^{th}, etc.). By way of example, the user may identify the alert time to be 8:30 AM on Friday, June 13^{th} using the schedule menu 640 such that at 8:30 AM on Friday, June 13^{th}, the alert 604 is provided to the vehicle 10. In some embodiments, the alert time included in the alert 604 includes a range of times, a range of days of the week, and/or a range of dates. By way of example, the user may identify the alert time to be a range of times such as 12:00 PM through 1:00 PM using the schedule menu 640 such that the alert 604 is provided (e.g., continuously provided) at/during the time range of 12:00 PM through 1:00 PM.

As shown in FIG. 10, the schedule menu 640 is configured to provide the user with the ability to identify whether the alert time included in the alert 604 is recurring and identify a frequency at which the alert time recurs. In some embodiments, the frequency is daily such that the alert 604 is provided at the alert time daily. By way of example, the user may identify the alert time to be 7:30 AM and set the alert time to recur daily such that the alert 604 is provided everyday at 7:30 AM. By way of another example, the user may identify the alert time to be a range of times from 12:00 PM through 1:00 PM and set the alert time to recur daily such that the alert 604 is provided everyday at/during the time range of 12:00 PM through 1:00 PM. In other embodiments, the frequency is weekly. By way of example, the user may set the alert time to recur every Monday at 9:00 AM such that the alert 604 is provided at 9:00 AM every Monday. By way of another example the user may set the alert time to recur every Wednesday and Friday at 3:00 PM such that the alert 604 is provided at 3:00 PM on both Wednesday and Friday each week. In yet other embodiments, the frequency is monthly. By way of example, the user may set the alert to recur on the first day of every month at 10:00 AM such that the alert 604 is provided at 10:00 AM on the first day of each month. In still other embodiments, the frequency is otherwise identified (e.g., semi-daily, bi-weekly, quarterly, yearly, etc.) such that the alert 604 is provided on a recurring basis in accordance with the schedule.

According to an exemplary embodiment, the schedule associated with the alert 604 is identified (e.g., established, created, etc.) in accordance with a schedule (e.g., an event) of the golf course 500. In such an embodiment, the schedule associated with the alert 604 may be identified based on the hours of operation of the golf course 500. By way of example, the alert 604 including a welcome message (e.g., “Welcome,” “Enjoy Your Round,” etc.) may be provided to the vehicle 10 when the golf course 500 opens for the day. By way of another example, the alert 604 including an end of day message (e.g., “Please Return Your Cart to the Clubhouse,” “The Golf Course Closes as 7:00 PM,” etc.) may be provided to the vehicle 10 when the golf course 500 closes for the day. In such an example, the alert time may be sequentially before the golf course 500 closes for the day such that the alert 604 is provided prior to the golf course 500 closing (e.g., to give the golfers time to return the vehicle 10 to the clubhouse). In some embodiments, the schedule associated with the alert 604 is identified based on a tournament (e.g., outing) hosted at the golf course 500. By way of example, the alert 604 including a welcome message (e.g., “Welcome,” “Enjoy Your Tournament,” etc.), a rules message (e.g., a message including rules of the tournament), an advertisement (e.g., a message from one or more advertisers of the tournament), among other messages may be provided to the vehicle 10 prior to and/or periodically during the tournament. In some embodiments, the schedule associated with the alert 604 is identified based on the season of the year (e.g., spring, summer, fall, winter). By way of example, the alert 604 including a warning of wet conditions may be provided to the vehicle 10 during wet/rainy seasons such as spring. By way of another example, the alert 604 including an advertisement for a cold beverage may be provided to the vehicle 10 during warm/dry seasons such as summer.

The schedule created using the schedule element 636 and the schedule menu 640 may be associated with a respective alert 604 being created using the alert dashboard 620. By way of example, the user may generate a respective alert 604 using one or more of the type alert button 624, the audio button 628, or the media button 632 and identify a schedule associated with the respective alert 604. By way of another example, the user may select an existing or previously generated alert 604 and configure (e.g., edit, identify, etc.) the schedule associated with the existing or previously generated alert 604.

As shown in FIG. 10, the alert dashboard 620 includes a fifth element, shown as vehicle menu 644, configured to provide the user with the ability to identify one or more of the vehicles 10 (e.g., based the type of the vehicle 10, based on an identification of the vehicle 10, a sub-set of vehicles 10, etc.) that the alert 604 is provided to. In other words, the alert 604 may or may not be provided to the vehicle 10 depending on whether the vehicle 10 is selected via the vehicle menu 644. By way of example, a first vehicle type may not receive the alert 604 at the alert time (if the first vehicle type is not selected via the vehicle menu 644) and a second vehicle type may receive the alert 604 at the same alert time (if the second vehicle type is selected via the vehicle menu 644). In such an example, a vehicle 10 configured as a drink cart, a cart driven by an employee of the golf course 500 monitoring the pace of play of golfers, a cart driven by the maintenance crew working at the golf course 500, a lawnmower, a turf mower, a push mower, a ride-on mower, a stand-on mower, aerator, turf sprayers, bunker rake, and/or another type of chore product (i.e., a vehicle 10 of the first vehicle type) may not receive the alert 604 (e.g., such as an alert 604 including a message to return the vehicle 10 to the clubhouse), while a golf cart driven by a golfer (i.e., a vehicle 10 of the second vehicle type) may receive the alert 604 at the alert time. In some embodiments, the vehicle menu 644 is configured to provide the user with the ability to set a credential level of the operator of the vehicle 10 to which the alert 604 is provided. In other words, the alert 604 may or may not be provided to the vehicle 10 depending on the credentials associated with the vehicle 10 and/or the credentials of the operator of the vehicle 10. By way of example, at the alert time, (i) the vehicle 10 may not receive the alert 604 if the operator of the vehicle 10 is an employee, for example, and if the credentials associated with the operator are not identified (e.g., selected via the vehicle menu 644) to receive the alert 604 and (ii) the vehicle 10 may receive the alert 604 if the operator is a golfer, for example, and if the credentials associated with the operator are identified (e.g., selected via the vehicle menu 644) to receive the alert 604.

As shown in FIG. 10, the alert dashboard 620 includes a sixth element, shown as condition button 648, configured to provide the user with the ability to identify an alert condition associated with the alert 604. The alert condition may be included in the alert 604 such that the alert 604 is provided in response to the alert condition being satisfied (e.g., in response to one or more parameters, criteria, etc., of the alert condition being met). In some embodiments, the alert 604 is provided (i) at or after the alert time and/or (ii) in response to the alert condition being satisfied. In some embodiments, the alert condition is associated with the type of the vehicle 10 and/or the credentials associated with the vehicle 10 or the operator of the vehicle 10, as discussed above. By way of example, the alert condition may be satisfied when a respective type of the vehicle 10 is selected via the vehicle menu 644, such that the alert 604 is provided to the vehicle 10 of the respective type. In such an example, if the respective type of the vehicle 10 is not selected via the vehicle menu 644, the alert condition may not be satisfied and the alert 604 may not be provided to the vehicle 10.

In some embodiments, the alert condition is satisfied when an outdoor temperature reaches a temperature threshold, such that the alert 604 is provided to the vehicle 10 when the outdoor temperature reaches the temperature threshold. By way of example, the alert condition may be satisfied when the outdoor temperature exceeds (e.g., is greater than) the temperature threshold. In such an example, the alert 604 may include a message (e.g., advertisement) notifying the operator of the vehicle 10 of cold beverages available from a drink cart, cold beverages at a restaurant/bar at the clubhouse, among other messages. By way of another example, the alert condition may be satisfied when the outdoor temperature drops below (e.g., is less than) the temperature threshold. In such an example, the alert 604 may include a message (e.g., advertisement) notifying the operator of the vehicle 10 of warm beverages available from a drink cart, warm beverages at a restaurant/bar at the clubhouse, among other messages. The temperature threshold may be input (e.g., set) by the user using the condition button 648.

In some embodiments, the alert condition is based on a weather condition and the alert condition is satisfied when the weather condition exceeds a weather condition threshold. By way of example, the weather condition may exceed the weather condition threshold during poor weather conditions (e.g., while it is raining or after it has rained, rained more than 1 inch in a 24 hour period, after a rain event, etc.) such that the alert 604 is provided when the weather condition exceeds the weather condition threshold. In such an example, the alert 604 may include an indication of the weather conditions such as a real-time radar, temperature, precipitation, wind, etc. The weather condition threshold may be input (e.g., set) by the user using the condition button 648.

In some embodiments, the alert condition is based on a location of the vehicle 10 such that the alert 604 is provided based on the location of the vehicle 10. In such embodiments, the alert condition may be satisfied in response to the vehicle 10 crossing into a respective geofence 514. By way of example, in response to a determination that the vehicle 10 is operating in a message geofence, the alert 604 may be indicative of a message (e.g., from the clubhouse). By way of another example, in response to a determination that the vehicle 10 is operating in an advertisement geofence, the alert 604 may be generated indicative of an advertisement (e.g., from a business, from the clubhouse, etc.).

In some embodiments, the alert 604 is provided to the operator of the vehicle 10 in response to the alert condition being satisfied when the violations (e.g., crossing into a restricted area defined by the geofence 514) exceed a violation threshold. By way of example, the violation threshold may be a violation count threshold, such that when a number of violations (e.g., violation instances) of a respective geofence 514 or a total number of violations for a group of geofences 514 exceed the violation count threshold, the alert 604 is provided. By way of another example, the violation threshold may be a threshold of a percentage of vehicles 10 committing a violation within a duration of time (e.g., a predetermined timeframe), such that when the percentage of vehicles 10 committing a violation in a respective geofence 514 or a respective campaign exceed the violation threshold, the alert 604 is provided. By way of yet another example, the violation threshold may be a violation duration threshold, such that when a violation duration of a respective geofence 514 exceeds the violation duration threshold, the alert 604 is provided.

In some embodiments, the alert 604 is indicative of a location of the geofence 514. By way of example, in response to a determination that the vehicle 10 is operating in or near a restricted area (e.g., near or in the geofence 514, near or in a keep-out geofence, etc.), the fleet monitoring and control system 200 may provide the alert 604 indicative of the location of the restricted area (e.g., a boundary of the geofence 514). In some embodiments, the alert 604 is indicative of a message (e.g., a text alert, a video alert, an audio alert, etc.). By way of example, in response to a determination that the location of the vehicle 10 indicates that the vehicle 10 is in an area (e.g., a drivable area) defined by the geofence 514 (e.g., a message geofence), the fleet monitoring and control system 200 may provide the alert 604 indicative of the message.

In some embodiments, the alert condition is satisfied when a location of the vehicle 10 indicates that the vehicle 10 is in an area within a predefined distance (e.g., 400 yards, 300 yards, 200 yards, a length of one hole of the golf course 500, etc.) from another vehicle 10 or walker (e.g., a golfer walking on the golf course 500). By way of example, a first vehicle 10 (e.g., a golf cart driven by a golfer) may be within the predefined distance from a second vehicle 10 (e.g., a golf cart driven by a golfer, a drink cart, a cart driven by an employee of the golf course 500 monitoring the pace of play of golfers, a cart driven by the maintenance crew working at the golf course 500, a lawnmower, a turf mower, a push mower, a ride-on mower, a stand-on mower, aerator, turf sprayers, bunker rake, and/or another type of chore product). In such an example, in response to the alert condition being satisfied based on the location of the first vehicle 10 relative to the second vehicle 10, the fleet monitoring and control system 200 is configured to provide the alert 604 to the first vehicle 10 and/or the second vehicle 10. Further, in such an example, the alert 604 may be indicative of the location of the first vehicle 10 and/or the second vehicle 10 (e.g., a map of the golf course 500 including an indication of the location of the first vehicle 10 and/or the second vehicle 10 on the map).

In some embodiments, the alert condition is satisfied when a location of the vehicle 10 indicates that the vehicle 10 is in an area within a predefined distance (e.g., 100 yards, 50 yards, 10 feet, 5 feet, 1 foot, etc.) from one or more features of the golf course 500 (e.g., the tee box 502, the fairway 504, the out-of-bounds area 506, the green 508, the hazard 510, the cart path 512, etc.). By way of example, in response to the alert condition being satisfied based on the location of the vehicle 10 being within the predefined distance from a respective hazard 510 on the golf course 500, the fleet monitoring and control system 200 may provide the alert 604 to the vehicle 10 indicative of the location of the respective hazard 510. By way of another example, in response to the alert condition being satisfied based on the location of the vehicle 10 being within the predefined distance from an area on the golf course 500 from which a golfer hitting a shot may be unable to see where their ball lands (e.g., a blind shot), the fleet monitoring and control system 200 may provide the alert 604 to the vehicle 10 indicative of the area (e.g., a message instructing the golfer to drive/walk ahead to ensure there are no people in an obstructed landing area).

In some embodiments, the alert condition is satisfied when the fleet monitoring and control system 200 determines that the operator of the vehicle 10 is present in the vehicle 10. By way of example, the sensors 90 may include a seat switch (e.g., a limit switch, a position sensor, a mechanical switch, etc.) configured to facilitate detecting whether an operator is sitting on the front row seating 32 or the rear row seating 34. In such an example, the seat switch may be coupled with the front row seating 32 or the rear row seating 34 such that when the operator sits in the front row seating 32 or the rear row seating 34, the front row seating 32 or the rear row seating 34 comes into contact or otherwise engages the seat switch. Responsive to engagement of the seat switch, a determination may be made by the fleet monitoring and control system 200 that the operator is sitting in the front row seating 32 or the rear row seating 34. By way of another example, the sensors 90 may include another type of sensor (e.g., vision sensor, camera, occupancy sensor, etc.) configured to detect the presence or absence of the operator in the front row seating 32 and/or the rear row seating 34.

In some embodiments, the alert 604 may include two or more alert conditions (e.g., two or more alert conditions may be identified and associated with the alert 604 using the vehicle menu 644 and/or the condition button 648) such that the alert 604 is provided to the vehicle 10 in response to each of the two or more alert conditions being satisfied. By way of example, a first alert condition may be satisfied when the fleet monitoring and control system 200 determines that the operator of the vehicle 10 is present in the vehicle 10, and a second alert condition may be satisfied based on a location of the vehicle 10. In such an example, the alert 604 may be provided to the vehicle 10 in response to a determination that both the first alert condition and the second alert condition are satisfied.

According to an exemplary embodiment, the alert 604 is selectively provided to the vehicle 10 based on whether the operator interface 48 of the vehicle 10 includes a device capable of providing the alert 604 to the operator of the vehicle 10 (e.g., such as a display and/or a speaker). In other words, the alert 604 may be provided to a first vehicle 10 including a device capable of providing the alert 604 and the alert 604 may not be provided to a second vehicle 10 that does not include a device capable of providing the alert 604.

According to an exemplary embodiment, the alert 604 is selectively provided to the vehicle 10 based on a determination by the fleet monitoring and control system 200 of whether the vehicle 10 is active (e.g., online, in operation, being used, etc.) or inactive (e.g., offline, not in operation, not being used, etc.). In some embodiments, the fleet monitoring and control system 200 determines whether the vehicle 10 is active or inactive based on a location of the vehicle 10. By way of example, when the location of the vehicle 10 indicates that the vehicle 10 is operating on the golf course 500 (e.g., not parked at the clubhouse, not in a parking lot, not in a garage for maintenance, etc.), the fleet monitoring and control system 200 may determine that the vehicle 10 is active. In some embodiments, the fleet monitoring and control system 200 determines whether the vehicle 10 is active or inactive based on a movement of the vehicle 10. By way of example, when a sensor 90 such as an IMU detects movement of the vehicle 10, the fleet monitoring and control system 200 may determine that the vehicle 10 is active, and when no movement of the vehicle 10 for an elapsed time is detected, the fleet monitoring and control system 200 may determine that the vehicle 10 is inactive. In some embodiments, the fleet monitoring and control system 200 determines whether the vehicle 10 is active or inactive based on the presence or absence of the operator in the vehicle 10. By way of example, when the seat switch is engaged, the fleet monitoring and control system 200 may determine that the operator is present in the vehicle 10 and that the vehicle 10 is active.

In some embodiments, the alert 604 is provided to the vehicle 10 in response to (i) a determination that the vehicle 10 is active and (ii) the alert condition (e.g., any one or more of the alert conditions described above and configurable via the vehicle menu 644 and/or the condition button 648) being satisfied or the alert time passing. In such embodiments, if a determination is made by the fleet monitoring and control system 200 that the vehicle 10 is inactive, the alert 604 may not be provided to the vehicle 10 (regardless of whether the alert condition is satisfied or the alert time passes). By way of example, the fleet monitoring and control system 200 may determine that a first vehicle 10 is active and that a second vehicle 10 is inactive. In such an example, in response to the alert condition being satisfied or the alert time passing, the alert 604 may be provided to the first vehicle 10 and may not be provided to the second vehicle 10. In some embodiments, the alert 604 is provided to the vehicle 10 in response to (i) a determination that the vehicle 10 is active and (ii) the alert condition being satisfied and the alert time passing. By way of example, the alert 604 may be provided in response to (i) a determination that the vehicle 10 is active, (ii) at 12:00 PM (e.g., at the alert time), and (iii) when the temperature reaches the temperature threshold (e.g., the alert condition being satisfied).

In some embodiments, a determination is made that the vehicle 10 is active and the alert time is passed, but a determination is made that the operator is absent from the vehicle 10 (e.g., if the operator is a golfer hitting a golf shot outside of the vehicle 10). In such embodiments, the alert 604 may not be provided (e.g., the alert 604 may be delayed from being provided) until a determination is made that the operator is present in the vehicle 10. In such embodiments, the alert 604 is provided after the alert time and in response to detecting that the operator is not in the vehicle 10 at the alert time.

In some embodiments, the alert 604 is selectively provided to the vehicle 10 based on a priority level associated with the alert 604. In such embodiments, a first alert 604 having a first priority may be provided instead of (e.g., may overrule) a second alert 604 having a second priority less (e.g., less severe, less important, etc.) than the first priority. By way of example, the first alert 604 may include a weather message (e.g., a radar) indicative of severe weather, and the second message may include an advertisement. In such an example, when (i) the first alert 604 is provided to the vehicle 10 and (ii) the alert time associated with the second alert 604 is passed or the alert condition associated with the second alert 604 is satisfied, the first alert 604 may remain provided (e.g., displayed, played, etc.) to the vehicle 10 because the second priority is less than the first priority.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the fleet monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A golf system comprising:
one or more processing circuits configured to:
generate an alert for an occupant of a golf vehicle, the alert including at least one of (i) an alert time or (ii) an alert condition;
determine that the golf vehicle is active; and
provide the alert to the occupant of the golf vehicle using at least one of a display device or a speaker of the golf vehicle, wherein the alert is provided at least one of (i) at or after the alert time or (ii) in response to the alert condition being satisfied.

2. The golf system of claim 1, wherein the one or more processing circuits are configured to provide the alert at the alert time.

3. The golf system of claim 1, wherein the one or more processing circuits are configured to provide the alert after the alert time in response to detecting that the occupant is not in the golf vehicle at the alert time.

4. The golf system of claim 1, wherein the one or more processing circuits are configured to provide the alert (i) at or after the alert time and (ii) in response to the alert condition being satisfied.

5. The golf system of claim 1, wherein the alert time is associated with an alert schedule defining an alert time frequency, and wherein the one or more processing circuits are configured to periodically provide the alert at the alert time frequency in accordance with the alert schedule.

6. The golf system of claim 1, wherein the alert time is prior to a time of an event such that the alert is provided before the time of the event.

7. The golf system of claim 1, wherein the one or more processing circuits are configured to provide the alert when the alert condition is satisfied, and wherein the alert condition is satisfied when an outdoor temperature reaches a temperature threshold.

8. The golf system of claim 1, wherein the one or more processing circuits are configured to provide the alert when the alert condition is satisfied, and wherein the alert condition is satisfied when a predetermined number of instances the golf vehicle has operated in a respective area exceeds a violation threshold.

9. The golf system of claim 8, wherein the respective area is defined by a geofence.

10. The golf system of claim 1, wherein the one or more processing circuits are configured to monitor a location of the golf vehicle, wherein the one or more processing circuits are configured to provide the alert when the alert condition is satisfied, and wherein the alert configured is satisfied when the location indicates that the golf vehicle in operating at a respective area.

11. The golf system of claim 10, wherein the golf vehicle is a first golf vehicle, and wherein the respective area is an area a predefined distance away from a second vehicle.

12. The golf system of claim 1, wherein the alert condition is a first alert condition, and wherein the one or more processing circuits configured to provide the alert in response to the first alert condition being satisfied and a second alert condition being satisfied.

13. The golf system of claim 1, wherein the one or more processing circuits are configured to provide the alert to the golf vehicle based on a type of the golf vehicle.

14. The golf system of claim 1, wherein the one or more processing circuits are configured to provide the alert to the golf vehicle based on credentials of the occupant of the golf vehicle.

15. The golf system of claim 1, wherein the golf vehicle includes a sensor configured to detect a presence of the occupant in the golf vehicle, and wherein the one or more processing circuits are configured to determine that the golf vehicle is active when the occupant is detected in the golf vehicle.

16. The golf system of claim 1, wherein the one or more processing circuits are configured to:
monitor a location of the golf vehicle; and
determine that the golf vehicle is active when the location indicates that the golf vehicle is moving.

17. The golf system of claim 1, wherein the one or more processing circuits include at least one of (i) a first processing circuit configured to be located on the golf vehicle or (ii) a second processing circuit configured to be located remote from the golf vehicle.

18. The golf system of claim 1, wherein the golf vehicle is one of a golf cart, an all-terrain vehicle, a utility task vehicle, a low speed vehicle, a lightweight or recreational vehicle, a lawnmower, a turf mower, a push mower, a ride-on mower, a stand-on mower, an aerator, a turf sprayer, or a bunker rake.

19. A golf system comprising:
a golf vehicle including an operator interface and a first processing circuit; and
a computing system remote from the golf vehicle, the computing system including a second processing circuit;
wherein:
the second processing circuit is configured to generate an alert for an occupant of the golf vehicle, the alert including at least one of (i) an alert time or (ii) an alert condition;
the second processing circuit is configured to determine that the golf vehicle is active;
the first processing circuit is configured to control the operator interface to provide the alert to the occupant of the golf vehicle; and
the alert is provided at least one of (i) at or after the alert time or (ii) in response to the alert condition being satisfied.

20. A golf system comprising:
one or more processing circuits configured to:
generate, remote from a golf vehicle, an alert for an occupant of the golf vehicle, the alert including at least one of (i) an alert time or (ii) an alert condition;
determine that the golf vehicle is active based on (i) a presence of the occupant in the golf vehicle or (ii) a location of the golf vehicle indicating that the golf vehicle is moving; and
provide the alert to the occupant of the golf vehicle using at least one of a display device or a speaker of the golf vehicle;
wherein the alert is provided at least one of (i) at or after the alert time or (ii) in response to the alert condition being satisfied; and
wherein the alert is provided based on a type of the golf vehicle such that the alert is provided to a first respective golf vehicle of a first type and not provided to a second respective golf vehicle of a second type different than the first type at least one of (i) at or after the alert time or (ii) in response to the alert condition being satisfied.
